(19) United States
(12) Patent Application Publication
(10) Pub. No.: US 2021/0080551 A1
(43) Pub. Date: Mar. 18, 2021

(54) LIDAR SYSTEM, OPERATING METHOD FOR A LIDAR SYSTEM, AND WORKING DEVICE

(71) Applicant: Robert Bosch GmbH, Stuttgart (DE)

(72) Inventors: Kai Worms, Hardthausen Am Kocher (DE); Michael Dreschmann, Stuttgart (DE)

(21) Appl. No.: 16/970,333

(22) PCT Filed: Jan. 18, 2019
(86) PCT No.: PCT/EP2019/051214

§ 371 Date: Aug. 14, 2020

(30) Foreign Application Priority Data
Feb. 14, 2018 (DE) 102018202246.1

(51) Int. Cl. G01S 7/481; G01S 17/931; G01S 7/00

(52) U.S. Cl. CPC G01S 7/4817; G01S 7/003; G01S 17/931

(57) ABSTRACT

A LIDAR system of the scanning type for the optical detection of a field of view a working device and/or a vehicle. The LIDAR system includes a stator, a rotor able to rotate about an axis of rotation in relation to the stator, a transmitter optics, a receiver optics and a communications unit for the contact-free data transmission between the stator and the rotor. At least part of the transmitter optics and/or part of the receiver optics is/are accommodated in the rotor, the communications unit has a first communications channel for the contact-free data transmission from the stator to the rotor, and a second communications channel for the contact-free data transmission from the rotor to the stator, and the first and the second communications channel are of a different nature.

### FIELD

The present invention relates to a LIDAR system, in particular of the sampling or scanning type, to an operating method for such a LIDAR system, and a working device and in particular a vehicle.

### BACKGROUND INFORMATION

When using working devices, vehicles and other machinery and systems, operating assistance systems or sensor systems are increasingly used for detecting the operating environment. In addition to video-based systems, radar-based systems or systems on the basis of ultrasound, light-based detection systems are used as well, e.g., what is known as LIDAR systems (light detection and ranging).

In sampling or scanning LIDAR systems, primary light, after being generated, is routed across a field of view to be detected. So-called macro scanners which have a rotor and a stator are used for this purpose. The rotor accommodates at least part of the optics system, the sensor system and/or the light sources and is rotatable in relation to the stator with the aid of a drive. All components of the rotor are supplied with energy, preferably in a contact-free or wireless manner, from the direction of the stator.

For example, an information exchange between the rotor and the stator is required for the control of the drive and the general operation and/or for the image reconstruction, for which quite different requirements may exist for the two directions.

PCT Application No. WO 2015/047872 A1 describes a rotatable LIDAR system in which an energy transmission from the stator to the rotor is carried out in a magneto-inductive manner and an information exchange between the rotor and stator is carried out in an electric-capacitive manner via electrically conductive rings.

### SUMMARY

An example LIDAR system according to the present invention may have the advantage that a reliable data exchange between the rotor and stator that satisfies the respective requirements is achievable using simple means. According to an example embodiment of the present invention, this may be achieved in that a LIDAR system of the sampling or scanning type is provided for the optical detection of a field of view, in particular for a working device and/or a vehicle, in which a stator, a rotor able to rotate about an axis of rotation in relation to the stator, a transmitter optics, a receiver optics, and a communications unit for the contact-free or wireless data transmission between the stator and rotor are developed, and at least part of the transmitter optics and/or part of the receiver optics is/are accommodated in the rotor. The communications unit has a first communications channel for a contact-free or wireless data transmission from the stator to the rotor, and a second communications channel for the contact-free or wireless data transmission from the rotor to the stator, the first and the second communications channels being of a different nature. On the one hand, these measures ensure that operating and control data for the operation of the LIDAR system and its components are able to be transmitted from the stator to the rotor and on the other hand, a return transmission of measured data acquired in the rotor using corresponding bandwidths is ensured.

In the above and the following text, the terms ‘contact-free’ and ‘wireless’ and also the terms ‘communication’ and ‘data transmission’ are used interchangeably. In addition, for example, the ‘nature’ of a communications channel is another term for the physical process that forms the basis of the respective communications channel, the physical communications means or the communications medium used in the process and/or the used signal type.

Preferred further developments of the present invention are described herein.

One main feature of the present invention is that the use of intrinsically different communications channels for the communications path from the stator to the rotor or from the rotor to the stator, is able to be realized in many different ways as long as it is ensured, for instance, that the physical process underlying the respective communications channel, the communications means used for this purpose, and/or the used signal type differ for the outgoing path and the return path.

For example, it is provided in one preferred embodiment of the LIDAR system according to the present invention that the first communications channel and the second communications channel are selected from the group of communications channels including optical communications channels, magneto-inductive communications channels, electrostatic-capacitive communications channels and their mixed forms. In the sense of the present invention, a mixed form of a communications channel is to be understood as a communications channel that provides no purely optical, magneto-inductive or electrostatic-capacitive data transmission or communication but that combines these with one another, in which case the three mentioned communications classes or communications types are able to be weighted as desired and combined with one another.

To realize the respective data transmission or communications process between the stator and rotor on the one hand and between the rotor and the stator on the other hand, a respective communications channel is advantageously developed with a transmitter unit on the transmitter side with regard to the data transmission or communication, for emitting signals representative of data to be transmitted, and with a receiver unit on the receiver side with regard to the data transmission or communication for the receiving of signals.

Of particular advantage is the use of optical communications channels inasmuch as these make it possible to realize a data transmission or communication at a high data rate with a large signal bandwidth.

As a result, in another exemplary embodiment of the LIDAR system according to the present invention, a respective optical communications channel is developed with an optical transmitter unit on the transmitter side with regard to the data transmission for emitting optical signals representative of data to be transmitted, and with an optical receiver unit on the receiver side with regard to the data transmission for receiving optical signals.

Different spectral ranges are able to be used for transmitting signals representative of data to be transmitted. For example, respective optical communications channels for the data transmission may be set up in the optically visible range, in the ultraviolet range and/or in the infrared range.

In addition, a respective optical communications channel may have one or more radiation emitters, e.g., LEDs and/or lasers, on the transmitter side with regard to the data transmission, and/or one or more radiation receivers, e.g., photodiodes, avalanche photodiodes, and/or photoresistors, on the receiver side with regard to the data transmission.

To realize a magneto-inductive data transmission or communication, it is advantageous if a magneto-inductive communications channel is developed with a magneto-inductive transmitter unit on the transmitter side with regard to the data transmission for the emitting of magnetic or magnetically modulated signals representative of data to be transmitted, and with a magneto-inductive receiver unit for the receiving of magnetic or magnetically modulated signals on the receiver side with regard to the data transmission.

In one advantageous further development of the LIDAR system according to the present invention, a respective magneto-inductive communications channel may have one or more transmitter coils on the transmitter side with regard to the data transmission and/or one or more receiver coils and/or Hall-effect sensors on the receiver side with regard to the data transmission.

LIDAR systems having a rotor and stator are frequently equipped with a contact-free and/or wireless energy supply where the rotor, for instance, is given an energy-supplying connection to the stator.

In this case, it is particularly advantageous if a transmitter coil and/or a receiver coil of a magneto-inductive communications channel is/are partially or completely developed at least as part of a primary coil on the stator side, and/or at least as part of a secondary coil of an underlying magneto-inductive energy supply system between the stator and rotor on the rotor side.

According to another advantageous specific embodiment of the LIDAR system according to the present invention, in order to realize an electrostatic-capacitive data transmission or communication, a respective electrostatic-capacitive communications channel may be developed to have an electrostatic-capacitive transmitter unit on the transmitter side with regard to the data transmission for the emitting of electrostatic or electrostatically modulated signals representative of data to be transmitted, and an electrostatic-capacitive receiver unit for the receiving of electrostatic signals or electrostatically modulated signals on the receiver side with regard to the data transmission.

In this case, a respective electrostatic-capacitive communications channel may have one or more transmitter electrodes on the transmitter side with regard to the data transmission, and/or one or a more receiver electrodes on the receiver side with regard to the data transmission.

In order to be able to properly consider the geometrical facts of a system made up of a rotor and stator, it may be advantageous if a respective communications channel is situated in parallel with the axis of rotation or extends at an angle. Particularly uncomplicated geometrical conditions are obtained in this way.

In this context it is possible that a respective optical communications channel is radially offset in relation to the axis of rotation in order to circumvent obstacles situated in the region of the axis of rotation in an advantageous manner.

On the other hand, a particularly high degree of compactness of the entire configuration of the communications unit results if a respective optical communications channel is situated in alignment with the axis of rotation of the underlying LIDAR system.

The data transmission or communication between the rotor and stator of a LIDAR system set up with the aid of these means is able to be used to particular advantage for the transmission of control data for the control of the rotation and/or for data representative of the general operation of the rotor from the stator to the rotor, and/or of receiver data and in particular for data representative of received signals from the rotor to the stator.

The LIDAR system according to the present invention may thus be quite generally set up for the transmission of control data for the control of the rotation and/or data representative of the general operation of the rotor from the stator to the rotor and/or for the transmission of receiver data and in particular for data representative of received signals from the rotor to the stator.

According to an alternative or additional view of the present invention, an operating method for a LIDAR system of the sampling or scanning type for the optical detection of a field of view and in particular for a working device and/or a vehicle is provided.

It is assumed that the LIDAR system is developed with a stator, a rotor able to rotate about an axis of rotation in relation to the stator, a transmitter optics, a receiver optics, and a communications unit for the contact-free or wireless data transmission between the stator and the rotor. In addition, it is assumed that at least part of the transmitter optics and/or part of the receiver optics is/are accommodated in the rotor.

A main features of the operating method according to the present invention is that the contact-free or wireless data transmission between the stator and rotor is carried out via a first communications channel for the contact-free or wireless data transmission from the stator to the rotor, and via a second communications channel for the contact-free or wireless data transmission from the rotor to the stator, and that first and second communications channels of a different nature are used from the group of communications channels, the group including optical communications channels, magneto-inductive communications channels, electrostatic-capacitive communications channels and their mixed forms.

According to a further aspect of the present invention, a working device and in particular a vehicle are also provided, which are developed with a LIDAR system developed according to the present invention for the optical detection of a field of view.

### BRIEF DESCRIPTION OF THE DRAWINGS

Specific example embodiments of the present invention are described in detail herein with reference to the figures.

FIG. 1 shows the structure of a specific embodiment of the LIDAR system according to the present invention in the form of a schematic block diagram.

FIGS. 2 and 3 show schematically, specific embodiments of the LIDAR system according to the present invention having a system of communications channels radially shifted in relation to an axis of rotation or having a flush alignment with the axis of rotation.

FIG. 4A through 4F show schematically, individual communications channels between a rotor and a stator of a LIDAR system in order to illustrate their different natures and communications directions.

FIGS. 5 and 6 show schematically, magneto-inductive communications channels between a rotor and a stator of a LIDAR system.

FIGS. 7 and 8 show schematically, electrostatic-capacitive communications channels between a rotor and a stator of a LIDAR system.

### DETAILED DESCRIPTION OF EXAMPLE EMBODIMENTS

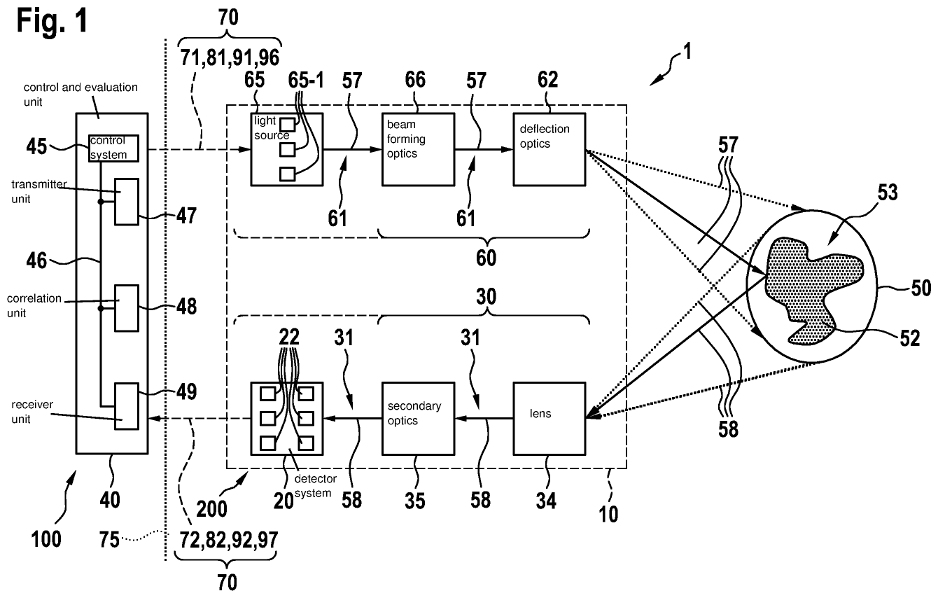

Below, exemplary embodiments of the present invention and the technical background are described in detail with reference to FIGS. 1 through 8. Identical and equivalent as well as similarly or equivalently acting elements and components are denoted by the same reference numerals. The detailed description of the denoted elements and components is not provided in all instances where they occur.

The illustrated features and further characteristics may be isolated from or combined with one another as desired without departing from the core of the present invention.

FIG. 1 shows a specific embodiment of LIDAR system 1 including an optical system 10 according to the present invention, in the form of a schematic block diagram.

As shown in FIG. 1, LIDAR system 1 has in its optical system 10 a transmitter optics 60 having an optical path 61, which is supplied by a light source unit 65 having light sources 65-1, in this instance in the form of lasers, for instance, and which emits primary light 57, possibly after passing through a beam forming optics 66 and via a deflection optics 62, into a field of view 50 for detecting an object 52 of a scene 53 located there.

In addition, LIDAR system 1 shown in FIG. 1 includes a receiver optics 30 having an optical path 31, which receives secondary light 58 reflected by object 52 in field of view 50 via a lens 34, as a primary optics and transmits it via a secondary optics 35 to a detector system 20 for the detection with the aid of sensor or detector elements 22. Secondary optics 35 may have a bandpass filter in order to reduce the effect of stray light.

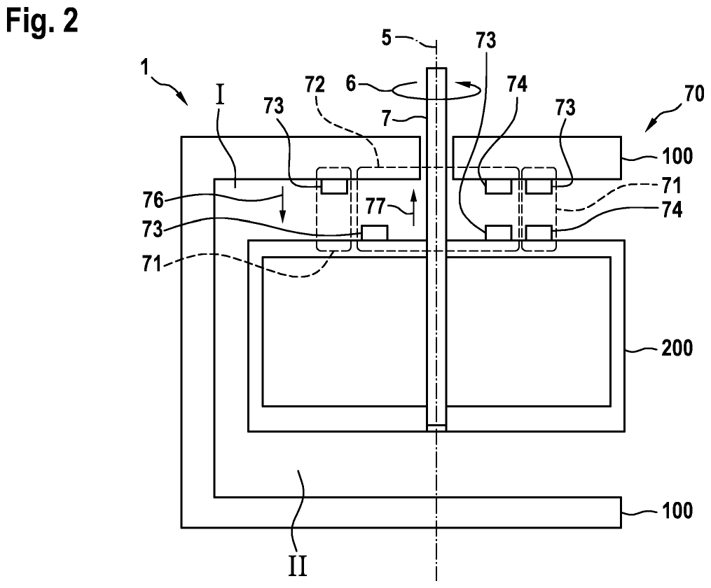

The control of rotation 6 of rotor 200, illustrated in FIG. 2 and the further figures, with the aid of shaft 7 shown there about axis of rotation 5 and in relation to stator 100, light source unit 65 having light sources 65-1, as well as detector system 20 is carried out via first and second communications channels 71 and 72, which are developed as first and second optical communications channels 81, 82 and as part of a communications interface 75, as well as with the aid of a control and evaluation unit 40.

Control and evaluation unit 40 may also assume the energy and/or data transmission between rotor 200 and stator 100, and in particular the control of a rotation drive. However, via control system 45 having a connection via a bus 46 to a transmitter unit 47, a receiver unit 49, and a correlation unit 48, control and evaluation unit 40 is particularly set up to carry out an evaluation of the radiation originating from field of view 50.

From FIG. 1 it may also be gathered that control and evaluation unit 40 is developed in the context of stator 100, whereas optical system 10 of LIDAR system 1 is essentially accommodated in rotor 200. However, such a configuration is not obligatory; for example, the radiation generation and/or the detection of the secondary radiation may certainly also be carried out in stator 100 provided corresponding optical waveguides are used from rotor 200 to stator 100.

The control of the operation of LIDAR system 1 of the present invention shown in FIG. 1 and the execution of a corresponding operating method are carried out with the aid of control system 45 shown in FIG. 1; in this control system 45 transmitter unit 47, receiver unit 49, and correlation unit 48 are connected to one another via a bus 46 and are operatively connected via communications interface 75 and communications channels 71 and 72, realized by a communications unit 70, to optical system 10 of LIDAR system 1 in rotor 200, and in particular to light source unit 65 and detector unit 20 of transmitter optics 60 or receiver optics 30.

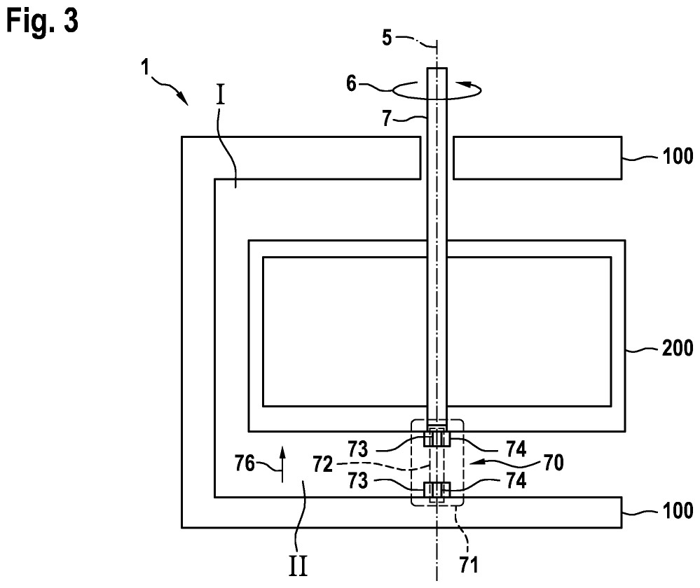

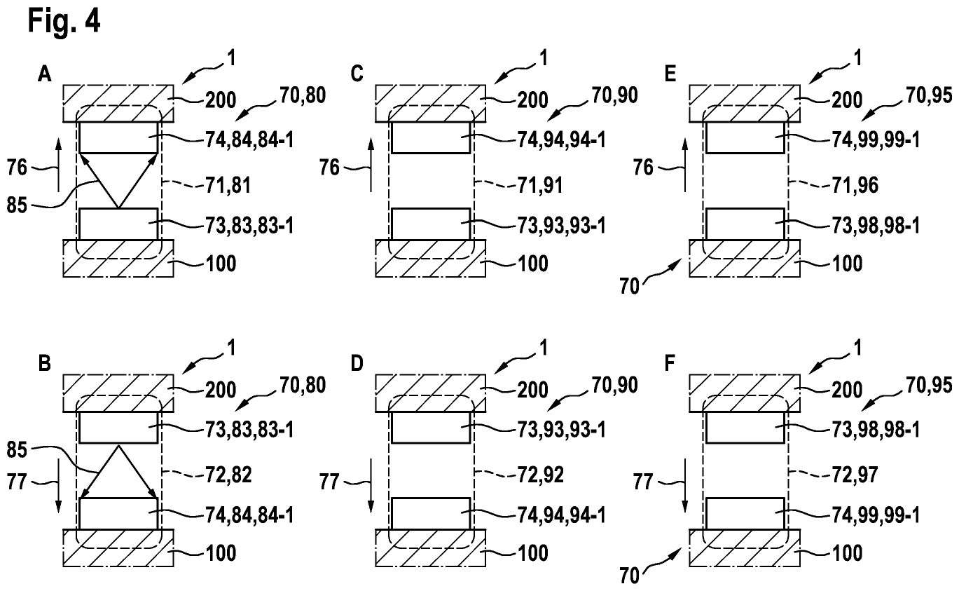

FIGS. 2 and 3 show schematic embodiments of LIDAR system 1 according to the present invention, having first and second general communications channels 71 and 72, which are shifted in relation to axis of rotation 5 or are aligned with axis of rotation 5 and are of a different nature in each case. Individual communications channels 71 and 72, as illustrated in detail in connection with further FIGS. 4 through 8, are able to be developed as optical communications channels 81, 82 of a respective optical communications unit 80, as magneto-inductive communications channels 91, 92 of a magneto-inductive communications unit 90, or as electrostatic-capacitive communications channels 96, 97 of an electrostatic-capacitive communications unit 95 between stator 100 and rotor 200 having a communications direction 76 from stator 100 to rotor 200 or having a communications direction 77 from rotor 200 to stator 100. As already mentioned in the previous text, communications channels 71, 72 featuring mixed forms of the data transmission or communication are also able to be used.

On the transmitter side, a respective communications channel 71, 72 has one or more transmitter units 73 and on the receiver side, it has one or more receiver units 74.

In the specific embodiment shown in FIG. 2, the two communications channels 71 and 72 are located in intersection region I, in this case on the upper side, between stator 100 and rotor 200; intersection region II remains free.

In the specific embodiment shown in FIG. 3, the two communications channels 71 and 72 are located in intersection region II, in this case on the underside, between stator 100 and rotor 200; intersection region I remains free.

Depending on the nature of a respective communications channel 71, 72, transmitter units 73 and receiver units 74 are also appropriately developed for establishing communications directions 76 and 77.

This is shown very generally in the following text in connection with FIGS. 4A through 4F. These figures thus schematically show individual communications channels 71, 72 between a rotor 200 and a stator 100 of a LIDAR system 1 in order to illustrate their different nature and communications direction 76, 77.

FIGS. 4A and 4B show in a LIDAR system 1 a communications unit 70 in the form of an optical communications unit 80 having first and second communications channels 71 and 72 in the form of a first optical communications channel 81 and a second optical communications channel 82 featuring a communications direction 76 from stator 100 to rotor 200 and a communications direction 77 from rotor 200 to stator 100, respectively. The respective transmitter units 73 are developed as optical transmitter units 83 and in particular as radiation emitters 83-1 for emitting radiation 85. The respective receiver units 74 are developed as optical receiver units 84 and in particular as radiation receivers 84-1 for recording and detecting radiation 85.

FIGS. 4C and 4D show in a LIDAR system 1 a communications unit 70 in the form of a magneto-inductive communications unit 90 having first and second communications channels 71 and 72 in the form of a first magneto-inductive communications channel 91 and a second magneto-inductive communications channel 92 with a communications direction 76 from stator 100 to rotor 200 and a communications direction 77 from rotor 200 to stator 100, respectively. The respective transmitter units 73 are developed as magneto-inductive transmitter units 93 and in particular as transmitter coils 93-1. The respective receiver units 74 are developed as magneto-inductive receiver units 94 and in particular as receiver coils 94-1.

In a magneto-inductive communications unit 90 of this type, signals that are representative of data to be transmitted are modulated onto a magnetic alternating field and emitted by transmitter coil 93-1 or magneto-inductive transmitter unit 93 in general, and received by receiver coil 94-1 or magneto-inductive receiver unit 94 in general and converted into an induction voltage, in particular.

FIGS. 4E and 4F show a communications unit 70 in the form of an electrostatic-capacitive communications unit 95 in a LIDAR system 1, the communications unit having first and second communications channels 71 and 72 in the form of a first electrostatic-capacitive communications channel 96 and a second electrostatic-capacitive communications channel 97 having a communications direction 76 from stator 100 to rotor 200 and a communications direction 77 from rotor 200 to stator 100. The respective transmitter units 73 are developed as electrostatic-capacitive transmitter units 98 and as transmitter electrodes 98-1, in particular. The respective receiver units 74 are developed as electrostatic-capacitive receiver units 99 and in particular as receiver electrodes 99-1.

In such an electrostatic-capacitive communications unit 95, signals representative of data to be transmitted are modulated onto an electrostatic field and in particular are modulated onto an electrostatic alternating field, and emitted by transmitter electrode 98-1 or an electrostatic-capacitive transmitter unit 98 in general and received by receiver electrode 99-1 or electrostatic-capacitive receiver unit 99 in general.

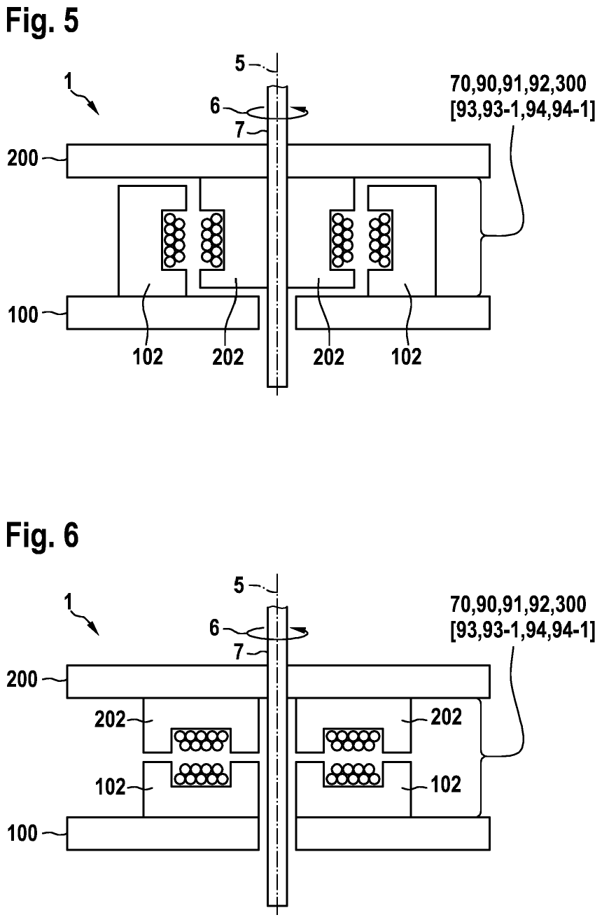

FIGS. 5 and 6 schematically show a LIDAR system 1 having magneto-inductive communications channels 91 and 92 of magneto-inductive communications units 90 between a rotor 200 and a stator 100 of LIDAR system 1.

As already stated quite generally in connection with FIGS. 4C and 4D, each one of magneto-inductive communications channels 91 and 92 of magneto-inductive communications unit 90 is realized by a system of magneto-inductive transmitter unit 93, such as a transmitter coil 93-1, and magneto-inductive receiver units 94 such as in the form of a receiver coil 94-1.

In the specific embodiment illustrated in FIG. 5, magneto-inductive communications channels 91 and 92 are developed approximately perpendicular to axis of rotation 5 in their alignment on account of the differently pronounced radial offset of transmitter coils 93-1 and receiver coils 94-1 with respect to each other and with respect to axis of rotation 5.

In the specific embodiment shown in FIG. 6, transmitter coils 93-1 and receiver coils 94-1 of the first and second magneto-inductive communications channels 91, 92 of magneto-inductive communications unit 90 have an identical axial offset in relation to axis of rotation 5. As a result, magneto-inductive communications channels 91 and 92 are aligned approximately in parallel with axis of rotation 5.

In the specific embodiments shown in FIGS. 5 and 6, transmitter coils 93-1 and receiver coils 94-1 are formed by a stator-side primary coil 102 and a rotor-side secondary coil 202 of an energy supply system 300 between stator 100 and rotor 200. However, such a development is not obligatory; in addition to primary coil 102 and secondary coil 202 of energy supply system 300, it is also possible to provide additional and separate transmitter coil wire 90-1 and receiver coils 94-1 for magneto-inductive communications unit 90.

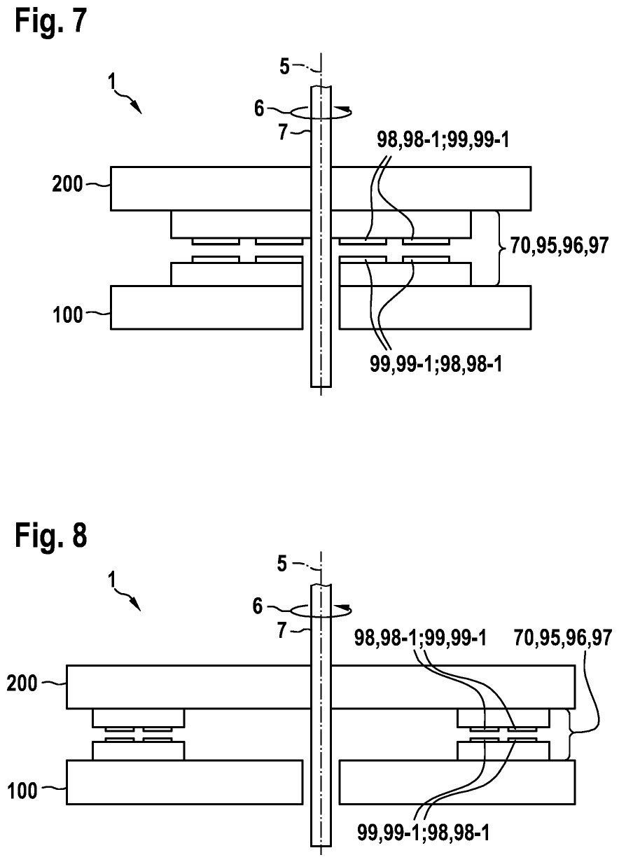

For a LIDAR system 1, FIGS. 7 and 8 schematically illustrate electrostatic-capacitive communications units 95 having electrostatic-capacitive communications channels 96 and 97 between a rotor 200 and a stator 100 of LIDAR system 1.

As has already been stated in quite general terms in connection with FIGS. 4E and 4F, first and second electric-capacitive communications channels 96 and 97 in a respective electrostatic-capacitive communications unit 95 are formed by one or more electrostatic-capacitive transmitter units 98, e.g., in the form of transmitter electrodes 98-1, as well as by one or more electrostatic-capacitive receiver units 99, e.g., in the form of receiver electrodes 99-1.

In the specific embodiment of LIDAR system 1 according to the present invention shown in FIG. 7, electrostatic-capacitive transmitter units 98 and electrostatic-capacitive receiver units 99 of electrostatic-capacitive communications unit 95 and corresponding communications channels 96 and 97 in the form of electrode rings or ring electrodes are situated on rotor 200 and stator 100 in a region close to the axis and concentrically with axis of rotation 5.

In the specific embodiment of LIDAR system 1 according to the present invention shown in FIG. 8, on the other hand, electrostatic-capacitive transmitter units 98 and electrostatic-capacitive receiver units 99 of electrostatic-capacitive communications unit 95 and the corresponding communications channels 96 and 97 in the form of electrode rings or ring electrodes are situated in a region on rotor 200 and stator 100 remote from the axis and concentrically with axis of rotation 5.

In the example systems shown in FIGS. 4A through 8, individual communications channels 71, 72 are shown in isolated form, that is to say, as purely optical, purely magneto-inductive or purely electrostatic-capacitive communications channels. This is used only for the schematic description whereas a core of the present invention consists especially of providing at least two communications channels 71, 72 of a different nature.

These and further features and characteristics of the present invention will be described in greater detail in the following text based on the following statements.

In the future, LIDAR systems are to be integrated into vehicles in invisible form, if possible. In order to do so, a LIDAR system must be given the most compact design possible.

At the same time, the demands with regard to the resolution and image repeat rate are increasing ever more.

For one, this results in a greater energy consumption of the components on rotor 200, and for another, in a growing volume of 3D data that has to be transported from rotor 200 to stator 100 in the form of an uplink. The data rate may reach up to 800 Mbit/s, for instance. A further data link in the form of a downlink is required for the control of the components on rotor 200. However, this downlink is able to be operated at a considerably lower data rate such as far below 100 Mbit/s in comparison with the uplink from rotor 200 to stator 100.

The energy and data transmission can be realized via a coupler on the LIDAR side and a coupler on the vehicle side. In addition to a coil for the energy transmission, both couplers require a pair of optical waveguides for the differential transmitting of data and a pair of optical waveguides for the differential receiving of data. In order to allow for a data transmission at any angle of rotation between rotor and stator, the optical waveguides are developed in the form of rings or ring segments.

The diameter of the coil pair for the energy transmission becomes larger as the energy consumption rises. The optical waveguides for the capacitive data transmission are usually located radially outside the coil. Their diameter therefore increases as well.

A system having such a diameter has the following disadvantages, among others:
Relatively high electromagnetic radiation of the underlying transmitter ring and a relatively high sensitivity of the underlying receiver ring with regard to electromagnetic immissions exists.
As the diameters of the optical waveguides become greater, the mechanical tolerances increase, which makes the production of the module for the data transmission more difficult.
The air circulation between rotor 200 and stator 100 is interrupted, which reduces the heat dissipation of the thermal power loss produced in the rotor.

If only one data channel is realized via the optical waveguide system, its diameter becomes smaller. The aforementioned disadvantages are reduced or even avoided as a consequence. Remaining communications channel 71, 72 is then realized via a communications unit 70, which is of a different nature, for instance based on optical or magnetic signals.

FIGS. 2 through 8 show different realization options of LIDAR system 1 according to the present invention.

When an optical communications unit 80 having optical communications channels 81, 82 is used, one or more light source(s) or radiation emitter(s) 83-1 being able to be developed as optical transmitter units 83, and/or a plurality of optical detectors in the form of radiation receivers 84-1 being able to be developed as radiation receivers 84 so that there will always be a line of sight between at least one light source 83-1 and at least one optical detector 84-1 notwithstanding an axial optical obstacle, i.e., by shaft 7, as it is shown in intersection region I shown in FIG. 2.

In the specific embodiment shown in FIG. 3, when using an optical communications unit 80, an optical data connection of the type of an optical communications channel 81, 82 exists on axis 5, for which a line of sight between a light source 83-1 and optical detector 84-1 exists at all times.

FIGS. 5 and 6 show example configurations of an inductive data transmission using a magneto-inductive communications unit 90. It constitutes an advantageous alternative for the low data rate such as in the case of a downlink from a rotor 200 to a stator 100, for instance because no active analog switching elements are required for the signal conditioning.

In one preferred variant, one of coils 102, 202 is used as transmitter coil 93-1 and a respective other one of coils 102, 202 is used as receiver coil 94-1. The wire windings of coils 102, 202 are preferably enclosed by the coil cores or iron cores such that the magnetic fields that emerge from coil pair 102, 202 are shielded.

In this context and in conjunction with the statements pertaining to FIGS. 1 and 2, a possible basic structure of a rotating LIDAR system 1 including rotor 200, stator 100 and a shaft 7 for fastening and for driving rotor 200 is also pointed out once again.

For the energy transmission, a magnetic field which is variable over time is able to be generated via an electric coil 102 as a primary coil on stator 100, the magnetic field inducing a current in electric coil 202 as a secondary coil of rotor 200 which is able to be used for the operation of the electric components of rotor 200.

As stated in connection with FIGS. 1 and 2, primary coil 102 and secondary coil 202 for energy transmission system 300 between stator 100 and rotor 200 may be situated in intersection region I or in intersection region II, that is to say, at a respective location in which an axial obstacle such as a shaft 7 is located, i.e., in intersection region I shown in FIG. 2, or in a location where axis 5 is unobstructed, i.e., in intersection region II shown in FIG. 3.

Coils 102, 202 of inductive energy transmission 300 are simultaneously also able to be used for an inductive data transmission and in this case fully or partly form the previously already described magneto-inductive transmitter and receiver units 93 and 94, i.e., transmitter coil 93-1 and receiver coil 94-1.

Depending on the design of LIDAR system 1, a realization of the data transmission by the combination of different data transmission methods within regions or intersection regions I and II is useful.

A capacitive data transmission may also be meaningful in combination with the optical or the inductive data transmission method.

A differential capacitive data transmission is schematically shown in FIGS. 7 and 8, where a ring pair having corresponding electrodes functions as an electrostatic-capacitive transmitter unit 98 and a ring pair having corresponding electrodes functions as electrostatic-capacitive receiver units 99. The ring pairs may be disposed near the axis as in FIG. 7 or at a distance from the axis as in FIG. 8.

A differential capacitive data transmission using an electrostatic-capacitive communications unit 95 also offers the option of changing transmitting direction 76, 77 during the propagation time so that a half-duplex connection is able to be realized. However, a combination of two communications channels 71, 72 of a different nature realizes a full duplex operation.

Different combination possibilities are described in the following text, depending on whether energy supply system 300 is situated in intersection region I or in intersection region II, as these are illustrated in connection with FIGS. 2 and 3.

If energy supply system 300 is disposed above in intersection region I, between stator 100 and rotor 200, shown in FIG. 2, then the following combinations of communications channels 71, 72 are possible, among others, the downlink denoting communications direction 76 from stator 100 to rotor 200, and the uplink denoting communications direction 77 from rotor 200 to stator 100:
optically as uplink in region II and inductively as downlink in region I with simultaneous use of coils 102, 202 of energy transmission 300,
optically as uplink in region II and inductively as downlink in region II,
optically as downlink in region I and capacitively as uplink in region I,
optically as downlink in region I and capacitively as uplink in region II,
optically as downlink in region II and capacitively as uplink in region I,
optically as downlink in region II and capacitively as uplink in region II,
optically in region II and capacitively in region I, uplink and downlink as desired,
optically in region II and capacitively in region II, uplink and downlink as desired,
inductively in region I with simultaneous use of coils 102, 202 of energy transmission 300 as downlink and capacitively as uplink in region I,
inductively in region I with simultaneous use of coils 102, 202 of energy transmission 300 as downlink and capacitively as uplink in region II,
inductively in region II as downlink and capacitively as uplink in region I and
inductively in region II as downlink and capacitively as uplink in region II.

If energy supply system 300 shown in FIG. 2 is below in intersection region II, between stator 100 and rotor 200, then the following combinations of communications channels 71, 72 are possible, among others:
optically as uplink in region II and inductively as downlink in region II with simultaneous use of coils 102, 202 of energy transmission 300,
optically as uplink in region II and inductively as downlink in region I,
optically as downlink in region I and capacitively as uplink in region I,
optically as downlink in region I and capacitively as uplink in region II,
optically as downlink in region II and capacitively as uplink in region I,
optically as downlink in region II and capacitively as uplink in region II,
optically in region II and capacitively in region I, uplink and downlink as desired,
optically in region II and capacitively in region II, uplink and downlink as desired,
inductively in region II with simultaneous use of coils 102, 202 of energy transmission 300 as downlink and capacitively as uplink in region I,
inductively in region II with simultaneous use of coils 102, 202 of energy transmission 300 as downlink and capacitively as uplink in region II,
inductively in region I as downlink and capacitively as uplink in region I, and
inductively in region I as downlink and capacitively as uplink in region II.

1-11. (canceled)

12. A LIDAR system of the scanning type for optical detecting of a field of view for a working device and/or a vehicle, comprising:
a stator;
a rotor configured to rotate in relation to the stator about an axis of rotation;
transmitter optics;
receiver optics; and
a communications unit configured for contact-free data transmission between the stator and the rotor;
wherein at least part of the transmitter optics and/or part of the receiver optics is accommodated in the rotor;
wherein the communications unit has a first communications channel for a contact-free data transmission from the stator to the rotor, and a second communications channel for a contact-free data transmission from the rotor to the stator; and
wherein the first and the second communications channels are of a different nature relative to one another.

13. The LIDAR system as recited in claim 12, wherein the first communications channel and the second communications channel are selected from a group of communications channels including: optical communications channels, magneto-inductive communications channels, electrostatic-capacitive communications channels, and mixed forms of channels.

14. The LIDAR system as recited in claim 12, wherein a respective one of the first communications channel and the second communications channel includes a transmitter unit on a transmitter side with regard to a data transmission, for emitting of signals representative of data to be transmitted, and with a receiver unit on a receiver side with regard to the data transmission, for receiving of signals.

15. The LIDAR system as recited in claim 12, wherein one of the first communications channels and the second communications channel is an optical communications channel, wherein the optical communication channel:
includes an optical transmitter unit on a transmitter side with regard to a data transmission for emitting of optical signals representative of data to be transmitted, and with an optical receiver unit on a receiver side with regard to the data transmission for receiving of optical signals; and/or
is configured to transmit signals representative of data to be transmitted in an optically visual range, in an ultraviolet range and/or an infrared range; and/or
includes one or more radiation emitters, and/or LEDs and/or lasers on the transmitter side with regard to the data transmission; and/or
includes one or more radiation receivers, and/or photodiodes, and/or avalanche photodiodes, and/or photoresistors, on the receiver side with regard to the data transmission.

16. The LIDAR system as recited in claim 12, wherein one of the first communications channel and the second communications channel is a magneto-inductive communications channel, wherein the magneto-inductive communication channel:
includes a magneto-inductive transmitter unit on a transmitter side with regard to a data transmission, for emitting of magnetic or magnetically modulated signals representative of data to be transmitted, and a magneto-inductive receiver unit on a receiver side with regard to the data transmission, for receiving of magnetic or magnetically modulated signals; and/or
includes one or more transmitter coils on the transmitter side with regard to the data transmission; and/or
includes one or more receiver coils and/or Hall-effect sensors on the receiver side with regard to the data transmission.

17. The LIDAR system as recited in claim 16, wherein a transmitter coil and/or a receiver coil is at least part of a primary coil on the stator, and/or at least as part of a secondary coil of a magneto-inductive energy supply system between the stator and rotor on a rotor side.

18. The LIDAR system as recited in claim 12, wherein one of the first communications channel and the second communications channel is an electrostatic-capacitive communications channel, wherein the electrostatic-capacitive communication channel:
includes an electrostatic-capacitive transmitter unit on a transmitter side with regard to a data transmission, for emitting of electrostatic or electrostatically modulated signal representative of data to be transmitted, and an electrostatic-capacitive receiver unit on a receiver side with regard to the data transmission, for receiving of electrostatic or electrostatically modulated signals; and/or
includes one or more transmitter electrodes on a transmitter side with regard to the data transmission; and/or
includes one or more receiver electrodes on a receiver side with regard to the data transmission.

19. The LIDAR system as recited in claim 12, wherein one of the first communications channel and the second communications channel is situated in parallel or extends at an incline to the axis of rotation and/or is radially offset in relation to or aligned with the axis of rotation.

20. The LIDAR system as recited in claim 12, where the data transmission between the stator and the rotor includes: (i) control data for control of rotation of the rotor and/or data representative of a general operation of the rotor, from the stator to the rotor, and/or (ii) data representative of received signals from the rotor to the stator.

21. An operating method for a LIDAR system of the scanning type for optical detection of a field of view for a working device and/or a vehicle, the LIDAR system includes a stator, a rotor able to rotate about an axis of rotation in relation to the stator, transmitter optics, receiver optics, and a communications unit configured for a contact-free data transmission between the stator and rotor, and at least part of the transmitter optics and/or part of the receiver optics is accommodated in the rotor, the method comprising:
carrying out the contact-free data transmission between the stator and the rotor via a first communications channel for contact-free data transmission from the stator to the rotor, and via a second communications channel for contact-free data transmission from the rotor to the stator;
wherein the first communications channel and the second communications channel are of a different nature from one another, the first communications channel and the second communications channel being selected from a group of communications channels including: optical communications channels, magneto-inductive communications channels, electrostatic-capacitive communications channels, mixed forms of channels.

22. A working device, comprising:
a LIDAR system for optical detection of a field of view, the LIDAR system including:
a stator;
a rotor configured to rotate in relation to the stator about an axis of rotation;
transmitter optics;
receiver optics; and
a communications unit configured for contact-free data transmission between the stator and the rotor;
wherein at least part of the transmitter optics and/or part of the receiver optics is accommodated in the rotor;
wherein the communications unit has a first communications channel for a contact-free data transmission from the stator to the rotor, and a second communications channel for a contact-free data transmission from the rotor to the stator; and
wherein the first and the second communications channels are of a different nature relative to one another.

23. The working device as recited in claim 22, wherein the working device is a vehicle.
